(19) United States
(12) Patent Application Publication
(10) Pub. No.: US 2021/0093064 A1
(43) Pub. Date: Apr. 1, 2021

(54) Suitcase Having A Receiving Compartment and a Rechargeable Battery

(71) Applicant: HORIZN STUDIOS GMBH, Berlin (DE)

(72) Inventor: Jan Hendrik Roosen, Berlin (DE)

(21) Appl. No.: 16/500,150

(22) PCT Filed: Mar. 29, 2018
(86) PCT No.: PCT/EP18/58241

§ 371 Date: Oct. 2, 2019

(30) Foreign Application Priority Data
Apr. 3, 2017 (DE) 202017101957.8

(51) Int. Cl. A45C 15/00; A45C 13/18; A45C 5/03; A45C 13/26

(52) U.S. Cl. CPC A45C 15/00; A45C 13/18; A45C 2005/037; A45C 13/26; A45C 5/03

(57) ABSTRACT

Hard shell case, comprising two hard shells, wherein a first hard shell comprises a receiving compartment, in which a rechargeable battery for charging an external electronic device is received, characterized in that the first hard shell comprises an external opening, via which the battery can be inserted into the receiving compartment in an insertion direction, wherein the receiving compartment comprises a fastening means, which, in a closed position, fastens the battery releasably and in a form-fit manner within the receiving compartment.

The invention relates to a hard shell case comprising two hard shells, wherein a first hard shell comprises a receiving compartment, in which a rechargeable battery for charging an external electronic device is received.

The invention further relates to a mounting unit for mounting to a recess of a first hard shell of a hard shell case, comprising a mounting frame which is connected to two mutually parallel receiving tubes, wherein rod-shaped legs of a U-shaped pulling frame are slidably guided within the receiving tubes, wherein the mounting frame comprises a receiving compartment which is arranged between the receiving tubes, wherein a rechargeable battery for charging an external electronic device is received in the receiving compartment.

Cases with batteries to which electronic devices, such as a mobile telephone, can be connected for charging are known. The battery and the case can have different life spans, or rather, the performance of the battery declines after frequent use. In addition, particularly in lithium-based batteries, there is a risk of ignition, meaning that, for cases with batteries of this type, the battery must be removed from the case before the case is checked in to be transported to a luggage compartment of an aircraft. For cases known from the art, it is common to mount the battery removably from the interior of the case. Therefore, for cases with batteries known from the art, exchanging the battery is elaborate, particularly if the case is already filled with items of clothing or the like.

Using a hard shell case of the aforementioned type as a basis, the object is to provide a hard shell case with a battery, wherein the battery can be exchanged more easily.

The object is achieved by the first hard shell comprising an external opening, via which the battery can be inserted into the receiving compartment in an insertion direction, wherein the receiving compartment comprises a fastening means, which, in a closed position, fastens the battery releasably and in a form-fit manner within the receiving compartment.

The object is additionally solved in that the mounting frame comprising an external opening, via which the battery can be inserted into the receiving compartment in an insertion direction, wherein the receiving compartment comprises a fastening means, which, in a closed position, fastens the battery releasably and in a form-fit manner within the receiving compartment.

The hard shell case according to the invention and the mounting unit according to the invention enable an easier handling of the battery. The battery may, if necessary, be removed without great effort. Exchanging the battery also requires less effort.

The mounting unit has the advantage that existing case models do not need to be redesigned in order to be able to incorporate a receiving compartment according to the invention.

It is particularly provided that the receiving compartment comprises a support plate for supporting the battery in its interior, wherein the support plate is subjected to a restoring force via at least one restoring means, wherein the restoring force acts opposite to the insertion direction. The support plate pushes against the battery in the direction of the opening. In particular, the support plate and the fastening means together have a fastening effect on the battery and fasten it in the receiving compartment. The restoring means is particularly designed in such a way that the support plate cushions the battery against shocks.

Preferably, it is provided that the support plate comprises two guiding means for guiding the support plate along the insertion direction in the receiving compartment and for preventing the support plate from jamming in the receiving compartment. This promotes the support plate being easily slidable.

Preferably, the restoring means is arranged at an end face of the receiving compartment that is opposite to the opening of the first hard shell and provides a stop for the support plate in the receiving compartment. This extends the life span of the guiding means and the support plate.

The fastening means is particularly subjected to a fastening force, which acts transversely, preferably perpendicularly, to the insertion direction and into the direction of the closed position. The fastening means thus automatically transitions to the closed position wherein it fastens the battery in the receiving compartment. The fastening force of the fastening means does not counteract the restoring force of the restoring means of the support plate but is transverse or perpendicular to it. Thus, the fastening means fastens the battery in the receiving compartment and not the means that subjects the fastening means to a fastening force.

The receiving compartment is preferably provided as a discrete part from the hard shells, wherein the receiving compartment is connected to the first hard shell and is completely received within the first hard shell. This facilitates mounting the receiving compartment in the hard shell case.

Preferably, the receiving compartment is provided as a housing having several parts. This facilitates mounting the support plate and the restoring means.

It is particularly provided that the fastening means is at least partially received in the receiving compartment and is connected to the receiving compartment. Consequently, the fastening force on the battery is preferably applied by the fastening means and the receiving compartment.

The receiving compartment particularly comprises a flange at the opening of the first hard shell which circumferentially encloses the opening, for mounting the receiving compartment to the first hard shell. The flange transmits the force which the receiving compartment is subjected to when the battery is inserted onto large areas of the hard shell. This extends the life span of the hard shell case.

The fastening means preferably rests slidably from the closed position to an open position and vice versa on the flange, wherein in the closed position the fastening means is connected to the flange in a form-fit manner. The flange is easily accessible, meaning that the fastening means can be mounted more easily. The form-fit connectability particularly improves the handling of the delicately designed fastening means during mounting.

Preferably, the flange completely receives the fastening means in the closed position. Consequently, the fastening means is well protected.

The fastening means particularly comprises a beveled insertion edge forming an acute angle with the insertion direction. By pushing the battery onto the edge of the fastening means, the fastening means is hereby easily pushed back.

An inclination angle of the beveled insertion edge of the fastening means that is proportional to the fastening force is particularly preferable. This facilitates the actuation of the fastening means.

The first hard shell preferably comprises a U-shaped pulling frame extractable from the first hard shell for pulling the hard shell case along, wherein the pulling frame comprises two rod-shaped legs which can be completely received in two mutually parallel receiving tubes of the first hard shell, wherein the receiving compartment is arranged between the two receiving tubes. The hard shell case is reinforced in the area of the pulling frame since it is subjected to increased forces in this area. Furthermore, the hard shell case comprises a recess for receiving the pulling frame in this area in any case, so that it does not need to be equipped with further areas in which the material is weakened in order to be able to mount the receiving compartment. The opening of the first hard shell is particularly preferably arranged between insertion openings of the receiving tubes, wherein the insertion direction of the battery corresponds to a slide-in direction of the legs of the U-shaped pulling frame into the receiving tubes.

It is particularly provided that the receiving compartment comprises a pivotable flap at the opening of the first hard shell for closing the receiving compartment, wherein the flap is releasably latched to the first hard shell in a closed state of the receiving compartment. The battery is protected from dirt, weather conditions and damage in the closed state of the receiving compartment.

The flap preferably covers the fastening means in the closed state of the receiving compartment. Therefore, the fastening means is protected from dirt, weather conditions and damage in the closed state of the receiving compartment.

It is preferably provided that the flap can be locked via a key lock in the closed state of the receiving compartment. Alternatively, the flap can be locked via a Transportation Security Administration lock (TSA-lock) in the closed state of the receiving compartment. The battery is thus protected from theft.

The flap particularly comprises a passage for passing through a plug of a charging cable. Thus, the battery can also be charged in the closed state of the receiving compartment.

Further advantageous embodiments of the invention follow from the following description of the Figures and the dependent sub-claims.

The figures show:

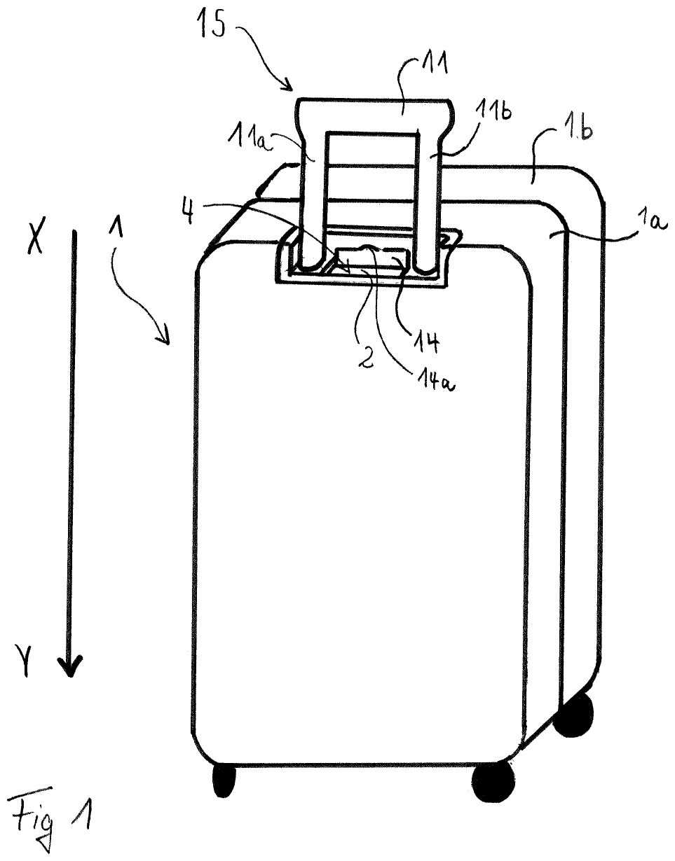

FIG. 1A view of a hard shell case according to the invention,

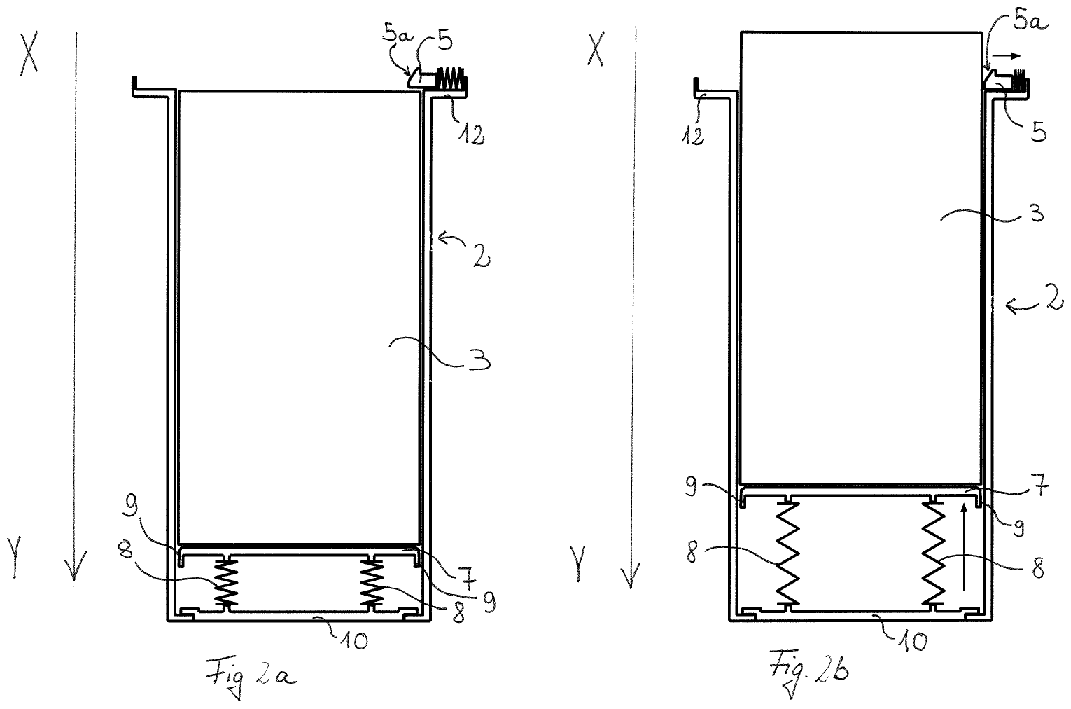

FIG. 2a a receiving compartment according to the invention with a completely received battery and a fastening means in the closed position and

FIG. 2b a receiving compartment according to the invention with a partially received battery and a fastening means in the open position.

In the various Figures of the drawings, same parts always have the same reference signs.

With regard to the following description, it is claimed that the invention is not limited to the embodiments and is further not limited to all or several features of described feature-combinations, but that each individual partial feature of the/each embodiment is independently of all other partial features described in the context of the embodiment in itself of significance to the subject matter of the invention, also in combination with any features of another embodiment.

A hard shell case 1 according to the invention with a receiving compartment 2 according to the invention is illustrated schematically in FIG. 1. The case 1 comprises two hard shells 1a, 1b. A first hard shell is of the case 1 comprises the receiving compartment 2. In the receiving compartment 2, a battery 3 that is not shown in FIG. 1 is received; however, the battery 3 is shown in FIGS. 2a and 2b. The first hard shell is comprises an opening 4, via which the battery 3 can be inserted into the receiving compartment 2 in an insertion direction X-Y.

FIG. 2a shows a cross section through the receiving compartment 2 along the insertion direction X-Y. In the illustration of FIG. 2a, the battery 3 is completely received in the receiving compartment 2 and is releasably fastened in a form-fit manner via a fastening means 5, wherein the fastening means 5 is in a closed position.

The battery 3 is rechargeable and is designed in such a way that it is suitable for charging an external electronic device, such as a mobile telephone, for example. Suitable batteries have a capacity of 10,000 mAh, for example, and have one or several suitable ports for connecting charging cables, such as a USB or mini USB cable and/or a port for charging the battery, for example.

The battery 3 can be removed from the receiving compartment 2 by transferring the fastening means 5 from the closed position into an open position. FIG. 2b shows the fastening means 5 in the open position. The fastening means 5 releases the battery 3 in the open position, so that it can be removed from the receiving compartment 2.

In order to facilitate removing the battery 3, the battery 3 is preferably subjected to a restoring force in the direction opposite to the insertion direction X-Y by the receiving compartment 2. The receiving compartment 2 particularly comprises a support plate 7 in its interior for this purpose. In particular, the support plate 7 is subjected to a restoring force via at least one restoring means 8 that acts opposite to the insertion direction X-Y. The restoring means 8 is preferably arranged at an interior end face 10 of the receiving compartment 2 that is opposite to the opening 4 with regard to the insertion direction X-Y. In particular, the restoring means 8 is attached to both the support plate 7, as well as to the receiving compartment 2, particularly at the end face 10. This has the advantage that the support plate 7 is captively fastened in the receiving compartment 2. The restoring means 8 is a spiral spring, for example. The restoring means 8 can absorb the shocks to which the case 1 is exposed during use.

It is particularly preferred that two restoring means 8 are provided that are arranged on both sides of a central longitudinal axis of the receiving compartment 2 extending along the insertion direction X-Y. This promotes the restoring means 8 being evenly subjected to a restoring force. At the same time, this reduces the possibility of the support plate 7 jamming in the receiving compartment 2.

The support plate 7 and the receiving compartment 2 are designed to align with one another such that the support plate 7 in the receiving compartment 2 is slidably guided along the insertion direction X-Y. Preferably, the support plate 7 is enclosed by the walls of the receiving compartment 2, wherein the support plate 7 particularly slidably rests on the walls of the receiving compartment 2.

The support plate 7 particularly comprises two guiding means 9 for guiding the support plate 7 along the insertion direction X-Y in the receiving compartment 2 and for preventing the support plate 7 from jamming in the receiving compartment 2. The guiding means 9 can be provided as two bars, for example, that extend away from the support plate 7 in the insertion direction X-Y.

The restoring means 8 preferably provides a stop for the support plate 7. This also means that the guiding means 9 are designed to be shorter along the insertion direction X-Y than the restoring means 8. When the battery 3 is then completely received in the receiving compartment 2, the restoring means 8 limit a sliding path of the battery 3 along the insertion direction X-Y, so that the guiding means 9 cannot hit the end face 10 of the receiving compartment 2. An impact of the guiding means 9 would cause a mechanical load to the support plate 7 and the guiding means 9.

In a preferred embodiment, the receiving compartment 2 comprises a fixing means, for example, at its end face 10. The fixing means is designed in such a way that it releasably fixes the support plate 7 to the end face 10 of the receiving compartment 2 when the battery 3 is completely received in the receiving compartment 2. The fixing means is preferably designed in such a way that the fixing is released when the battery 3 is pushed against the support plate 7 once again. The fixing means comprises an eyelet or a hook, for example, which extend from the support plate 7 in the direction of the end face 10 of the receiving compartment 2, as well as a locking mechanism that extends from the end face 10 of the receiving compartment 2 into the direction of the support plate 7 and releasably fixes the eyelet or the hook.

The fastening means 5 is particularly subjected to a fastening force which acts transversely to the insertion direction X-Y and into the direction of the closed position. The fastening force particularly acts perpendicularly to the insertion direction X-Y and into the direction of the closed position. The fastening force can, for example, be generated by a spiral spring associated with the fastening means 5 which is arranged between the receiving compartment 2 and the fastening means 5, see FIGS. 2a and 2b.

The fastening means 5 may be designed as latch. The fastening means 5 can fasten the battery 3 in the closed position by the fastening means 5 extending over the battery 3 in the closed position, see FIG. 2a. In this instance, the fastening means 5 cooperates with the support plate 7 since the support plate 7, which is subjected to the restoring force in the direction opposite to the insertion direction X-Y, pushes the battery 3 in the direction of the fastening means 5, so that the battery 3 is fastened firmly in the receiving compartment 2.

The receiving compartment 2 can be provided as a discrete part from the hard shells 1a, 1b. The receiving compartment 2 is preferably connected to the first hard shell is and is completely received within the first hard shell 1a. This has the advantage that the receiving compartment 2 as an additional part can be used as an upgrade. For example, the first hard shell is can comprise a recess for mounting the receiving compartment 2, in which the receiving compartment 2 can be received.

The receiving compartment 2 can, for example, be arranged in the region of receiving tubes for partially receiving pulling frames 11 for pulling the case 1 along, that are not shown here. For a case 1 with a U-shaped pulling frame 11 with two rod-shaped legs 11a, 11b, which can be completely received in two mutually parallel receiving tubes of the first hard shell 1a, the receiving compartment 2 can, for example, be arranged between the two receiving tubes, see FIG. 1.

The opening 4 of the first hard shell is is in particular arranged between insertion openings of the receiving tubes, wherein the insertion direction X-Y of the battery 3 corresponds to a slide-in direction of the legs 11a, 11b of the U-shaped pulling frame 11 into the receiving tubes. One possible embodiment in this respect is depicted in FIG. 1.

The receiving compartment 2 can be provided as a housing having several parts. The receiving compartment 2 according to the embodiment of FIGS. 2a and 2b has three parts. A plate of the receiving compartment 2 arranged at the end face 10 is preferably provided as a separate part of the housing. This has the advantage that the restoring means 8 can be easily connected to the receiving compartment 2. After mounting the restoring means 8 on the plate, the plate arranged at the end face can be connected to the other part(s) of the housing of the receiving compartment 2. Preferably, the plate and the other part(s) of the housing of the receiving compartment 2 is/are designed to align with one another in such a manner that the plate can be connected to the other part(s) of the housing in a form-fit manner.

The fastening means 5 is particularly at least partially received in the receiving compartment 2 and is connected to the receiving compartment 2. The fastening means 5 is thus protected from mechanical damage. For the fastening means 5, in particular an actuating portion is, at least partially, not enclosed by the receiving compartment 2 and is thus freely accessible for manual actuation.

The receiving compartment 2 preferably comprises a flange 12 at the opening 4 of the first hard shell is which circumferentially encloses the opening 4, for mounting the receiving compartment to the first hard shell 1a. By means of the flange 12, the receiving compartment 2 can be screwed to the first hard shell 1a, for example.

The fastening means 5 can rest slidably from the closed position to an open position and vice versa on the flange 12. Particularly in the closed position, the fastening means 5 is connected to the flange 12 in a form-fit manner. For example, the fastening means 5 can comprise a gradation, which runs transversely with regard to a sliding axis X-Z that runs between the open position and the closed position, and which in the closed position rests on an abutment shoulder of the receiving compartment 2. The fastening means 5 with its gradation is preferably pushed against the abutment shoulder via the fastening force in the closed position. A form-fit connection between the fastening means 5 and the receiving compartment 2 facilitates the mounting of the receiving compartment 2 since the correct installation position of the delicate fastening means can be controlled more easily.

The flange 12 in particular completely receives the fastening means 5 in the closed position. Particularly preferably, the receiving compartment 2 is connected to the first hard shell is in such a way and the hard shell is and the receiving compartment 2 are designed in such a way, that the fastening means 5 is covered by a housing of the first hard shell is in the closed position.

The fastening means 5 particularly comprises a beveled insertion edge 5a forming an acute angle with the insertion direction X-Y. The beveled insertion edge 5a facilitates pushing the fastening means 5 back into the open position when the battery 3 is pushed onto the beveled insertion edge 5a. The beveled insertion edge 5a preferably comprises an inclination angle with regard to the insertion direction X-Y which is proportional to the fastening force of the fastening means 5.

The receiving compartment 2 can preferably be closed via a pivotable flap 14. The pivotable flap 14 is particularly arranged at the opening 4 of the first hard shell is and can be pivotably connected to the first hard shell is via a film hinge, for example. The flap 14 is particularly releasably latched to the first hard shell is in a closed state of the receiving compartment 2. Additionally or alternatively, the flap 14 can be opened or closed via a flange 12 that can be moved from the outside and is manually actuable.

Preferably, the flap 14 covers the fastening means 5 in a closed state of the receiving compartment 2, even if said fastening means is in a closed position. The flap 14 can comprise a raised section 14a that is convex with respect to the opening 4, which facilitates opening the flap 14. In the area of the raised section 14a, the first hard shell 1a can comprise a corresponding concave notch.

The flap 14 can preferably be locked via a key lock in the closed state of the receiving compartment 2, which is not shown. Alternatively, the flap 14 can be locked via a Transportation Security Administration lock (TSA-lock).

The flap 14 can comprise a passage for passing through a plug of a charging cable, which is not shown. This passage can be closed by a closure flap, for example.

Furthermore, according to the invention, a mounting unit 15 is provided for mounting to a recess of a first hard shell 1a of a hard shell case 1. The mounting unit 15 comprises a mounting frame which is connected to two mutually parallel receiving tubes (not shown). Rod-shaped legs of a U-shaped pulling frame 11 are slidably guided within the receiving tubes. The mounting frame comprises the receiving compartment 2 which is arranged between the receiving tubes. The mounting unit 15 according to the invention facilitates mounting the receiving compartment 2 to the hard shell case 1.

The mounting unit particularly comprises an external opening 4 via which the battery 3 can be inserted into the receiving compartment 2.

The invention is not limited to the illustrated and described embodiments, but rather also includes all other embodiments that have an equal effect within the meaning of the invention. It is also explicitly emphasized that the embodiments are not limited to all features in combination; rather, each individual partial feature in itself can be of inventive significance independent of all other partial features. Furthermore, the invention is not yet limited to the combination of features defined in claim 1, but can rather also be defined by every other possible combination of specific features of all of the disclosed individual features. This means that, in principle, essentially every individual feature of claim 1 can be omitted or at least be replaced by an individual feature disclosed in a different part of the application.

### LIST OF REFERENCE SIGNS

1 Hard shell case

1a, 1b Hard shells

1a First hard shell

2 Receiving compartment

3 Battery

4 Opening of the first hard shell

5 Fastening means

5a Beveled insertion edge

7 Support plate

8 Restoring means

9 Guiding means

10 End face of the housing

11 U-shaped pulling frame

11a, 11b Legs of the U-shaped pulling frame

12 Flange

14 Flap

14a Raised section

15 Mounting unit

X-Y Insertion direction

1-25. (canceled)

26. A hard shell case, comprising:
two hard shells, wherein a first hard shell of the two hard shells comprises a receiving compartment in which a rechargeable battery for charging an external electronic device is receivable,
wherein the first hard shell further comprises an external opening via which the battery is insertable into the receiving compartment in an insertion direction, wherein the receiving compartment comprises a fastening means which, in a closed position, fastens the battery releasably and in a form-fit manner within the receiving compartment.

27. The hard shell case of claim 26,
wherein the receiving compartment comprises a support plate for supporting the battery in the interior of the receiving compartment, wherein the support plate is subjected to a restoring force via at least one restoring means, wherein the restoring force acts opposite to the insertion direction.

28. The hard shell case of claim 27,
wherein the support plate comprises two guiding means for guiding the support plate along the insertion direction in the receiving compartment and for preventing the support plate from jamming in the receiving compartment.

29. The hard shell case of claim 28,
wherein the at least one restoring means is arranged at an end face of the receiving compartment that is opposite to the opening of the first hard shell and provides a stop for the support plate in the receiving compartment.

30. The hard shell case of claim 26,
wherein the fastening means is subjected to a fastening force which acts transversely to the insertion direction and into the direction of the closed position.

31. The hard shell case of claim 30,
wherein the fastening means is subjected to a fastening force which acts perpendicularly to the insertion direction and into the direction of the closed position.

32. The hard shell case of claim 26,
wherein the receiving compartment is provided as a discrete part from the two hard shells, wherein the receiving compartment is connected with the first hard shell and is completely received within the first hard shell.

33. The hard shell case of claim 26,
wherein the receiving compartment is provided as a housing having several parts.

34. The hard shell case of claim 26,
wherein the fastening means is at least partially received in the receiving compartment and is connected to the receiving compartment.

35. The hard shell case of claim 26,
wherein the receiving compartment comprises a flange at the opening of the first hard shell which circumferentially encloses the opening for mounting the receiving compartment on the first hard shell.

36. The hard shell case of claim 35,
wherein the fastening means rests slidably from the closed position to an open position and vice versa on the flange, wherein in the closed position the fastening means is connected to the flange in a form-fit manner.

37. The hard shell case of claim 35,
wherein the flange completely receives the fastening means in the closed position.

38. The hard shell case of claim 26,
wherein the fastening means comprises a beveled insertion edge forming an acute angle with the insertion direction.

39. The hard shell case of claim 38,
wherein an inclination angle of the beveled insertion edge of the fastening means is proportional to the fastening force.

40. The hard shell case of claim 26,
wherein one or both of the restoring means or a means for subjecting the fastening means with the fastening force comprise spiral springs.

41. The hard shell case of claim 26,
wherein the first hard shell comprises a U-shaped pulling frame extractable from the first hard shell for pulling the hard shell case along, wherein the pulling frame comprises two rod- shaped legs which are completely receivable in two mutually parallel receiving tubes of the first hard shell, wherein the receiving compartment is arranged between the two receiving tubes.

42. The hard shell case of claim 41,
wherein the opening of the first hard shell is arranged between insertion openings of the receiving tubes, wherein the insertion direction of the battery corresponds to a slide-in direction of the legs of the U-shaped pulling frame into the receiving tubes.

43. The hard shell case of claim 26,
wherein the receiving compartment comprises a pivotable flap at the opening of the first hard shell for closing the receiving compartment, wherein the flap is releasably latched to the first hard shell in a closed state of the receiving compartment.

44. The hard shell case of claim 43,
wherein the flap covers the fastening means in the closed state of the receiving compartment.

45. The hard shell case of claim 43,
wherein the flap is lockable via a key lock in the closed state of the receiving compartment.

46. The hard shell case of claim 43,
wherein the flap is lockable via a Transportation Security Administration lock (TSA-lock) in the closed state of the receiving compartment.

47. The hard shell case of claim 43,
wherein the flap comprises a passage for passing through a plug of a charging cable.

48. The hard shell case of claim 43,
wherein the flap comprises a closure flap for closing the passage.

49. A mounting unit for mounting to a recess of a first hard shell of a hard shell case, the mounting unit comprising:
a mounting frame which is connected to two mutually parallel receiving tubes, wherein rod-shaped legs of a U-shaped pulling frame are slidably guided within the receiving tubes, wherein the mounting frame comprises a receiving compartment which is arranged between the receiving tubes, wherein a rechargeable battery for charging an external electronic device is receivable in the receiving compartment, wherein the mounting frame further comprises an external opening via which the battery can be inserted into the receiving compartment in an insertion direction, wherein the receiving compartment comprises a fastening means which, in a closed position, fastens the battery releasably and in a form-fit manner within the receiving compartment.
